(19) United States
(12) Patent Application Publication
(10) Pub. No.: US 2023/0259344 A1
(43) Pub. Date: Aug. 17, 2023

(54) SYSTEM AND METHOD FOR TRACKING AND INSTALLING MISSING SOFTWARE APPLICATIONS

(71) Applicant: Saudi Arabian Oil Company, Dhahran (SA)

(72) Inventor: Mohammed Mujtaba, Dhahran (SA)

(21) Appl. No.: 17/651,360

(22) Filed: Feb. 16, 2022

(51) Int. Cl. G06F 8/61; G06F 8/65; H04L 61/5007

(52) U.S. Cl. CPC G06F 8/61; G06F 8/65; H04L 61/2007

(57) ABSTRACT

A method for tracking and installing missing software applications and other computer resource assets on a target list includes scanning a port for the missing computer resource asset, and, if the port is not active, pinging the missing computer resource asset and either remediating the missing computer resource or performing a reverse lookup of an IP address of the pinged computer resource asset to obtain a reverse lookup name, depending on whether there is a response to the ping. Actual computer resource asset names which match the reverse lookup name are checked whether enabled in an active directory database in which case the pinged computer resource asset is enabled, and in the absence of a match, a check is made whether the reverse lookup name is missing from a separate target list, in which case the pinged computer resource asset is remediated. The system implements the method.

### FIELD OF THE DISCLOSURE

The present disclosure relates generally to monitoring installed software applications on a computer, and, more particularly, to a system and method for tracking and installing missing software applications on computer systems.

### BACKGROUND OF THE DISCLOSURE

An organization can deploy a large number of hardware-based computer resource assets, such as workstations and servers, as well as facilities such as a network to interact with mobile users using cellphones, smartphones, and tablets. In addition, such hardware-based computer resource assets can employ a huge base of software applications such as client software as well as diverse operating systems. For the security of an organization, anti-virus software as well as other security applications can be mandatory to be installed on the computer resource assets of the organization.

With such large numbers of computer resource assets, including both hardware-based elements and software applications, an organization can encounter difficulty in tracking which computer resource assets are missing on a particular computer system. In addition, if security applications are missing or corrupted, the operating efficiency and functionality of the organization can be compromised.

### SUMMARY OF THE DISCLOSURE

According to an embodiment consistent with the present disclosure, a system and method track and install missing software applications on computer systems.

In an embodiment, a method is configured to install a missing computer resource asset, comprising: receiving a management list of computer resource assets from a computer resource asset management system; sorting the management list according to the names of the listed computer resource assets in the management list; receiving a target list of computer resource assets; comparing the sorted management list with the target list; if the sorted management list does not match the target list, scanning a port for the missing computer resource asset; if the port is not active, pinging the missing computer resource asset; if no response to the ping is received, remediating the missing computer resource asset; if a response to the ping is received, performing a reverse lookup of an IP address of the pinged computer resource asset to obtain a reverse lookup name; if the reverse lookup name matches an actual computer resource asset name, checking whether the reverse lookup name is listed as enabled in an active directory database; if the reverse lookup name is listed as enabled in an active directory database, remediating the pinged computer resource asset; if the reverse lookup name does not match an actual computer resource asset name, checking whether the reverse lookup name is listed in the separate target list; and if the reverse lookup name is not listed in the separate target list, remediating the pinged computer resource asset.

The computer resource assets can be selected from the group consisting of: a workstation, a desktop computer, a laptop computer, a server, a cellphone, a smartphone, a tablet, a software application, an app, an applet, and a computer object. The remediating can include repairing the computer resource asset or installing the computer resource asset. The method can further comprise if the port is active, remediating the missing computer resource asset. Performing the reverse lookup can include performing a fully qualified domain name (FQDN) search. The management list can include a current deployment status of each computer resource asset in the management list. Alternatively, the management list can include all computer objects in a directory reported in a previous predetermined number of days. In addition, the management list can include all computer resource assets connected to a centralized database in a previous number of hours.

In another embodiment, a method is configured to install a computer application missing from a computer system, comprising: receiving, at the computer system, a management list of computer applications from a computer resource asset management system; sorting the management list according to the names of the listed computer applications in the management list; receiving a target list of computer applications; comparing the sorted management list with the target list; if the sorted management list does not match the target list, scanning a port for the missing computer application; if the port is not active, pinging the missing computer application; if no response to the ping is received, remediating the missing computer application; if a response to the ping is received, performing a reverse lookup of an IP address of the pinged computer application to obtain a reverse lookup name; if the reverse lookup name matches an actual computer application name, checking whether the reverse lookup name is listed as enabled in an active directory database; if the reverse lookup name is listed as enabled in an active directory database, remediating the pinged computer application; if the reverse lookup name does not match an actual computer application name, checking whether the reverse lookup name is listed in the separate target list; and if the reverse lookup name is not listed in the separate target list, remediating the pinged computer application.

The computer applications can be selected from the group consisting of: a software application, an app, an applet, and a computer object. The remediating can include repairing the computer application or installing the computer application. The method can further comprise if the port is active, remediating the missing computer application. Performing the reverse lookup can include performing a fully qualified domain name (FQDN) search. The management list can include a current deployment status of each computer application in the management list. Alternatively, the management list can include all computer objects in a directory reported in a previous predetermined number of days. In addition, the management list can include all computer applications connected to a centralized database in a previous number of hours.

In a further embodiment, a computer system comprises a processor, a memory, a communication interface, and a remediation module. The processor has code therein configured to operate a plurality of computer applications, including a predetermined computer application. The memory is configured to store a database of information regarding each computer application. The communication interface is operatively connected to a computer application management system. The remediation module has code therein configured to remediate the plurality of computer applications. The processor determines whether a specific computer application is missing from the memory using the predetermined computer application. The remediation module is responsive to the predetermined computer application to remediate the plurality of computer applications to include the specific computer application.

The remediation module can remediate by repairing an installed computer application to be the missing computer application or by installing the missing computer application in the memory. The communication interface includes a port, and the processor can determine whether the missing computer application is active on the port. The processor can receive a management list of computer applications from the computer application management system, and determines whether there is a match of the management list with a target application list stored in the memory. If there is no match, the remediation module can remediate the plurality of computer applications to include the specific computer application.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a schematic of a system, according to an embodiment.

FIGS. 2A-2D are flowcharts of a method, according to the embodiment.

It is noted that the drawings are illustrative and are not necessarily to scale.

### DETAILED DESCRIPTION OF CERTAIN EMBODIMENTS OF THE DISCLOSURE

Example embodiments consistent with the teachings included in the present disclosure are directed to a system and method which track and install missing software applications on computer systems.

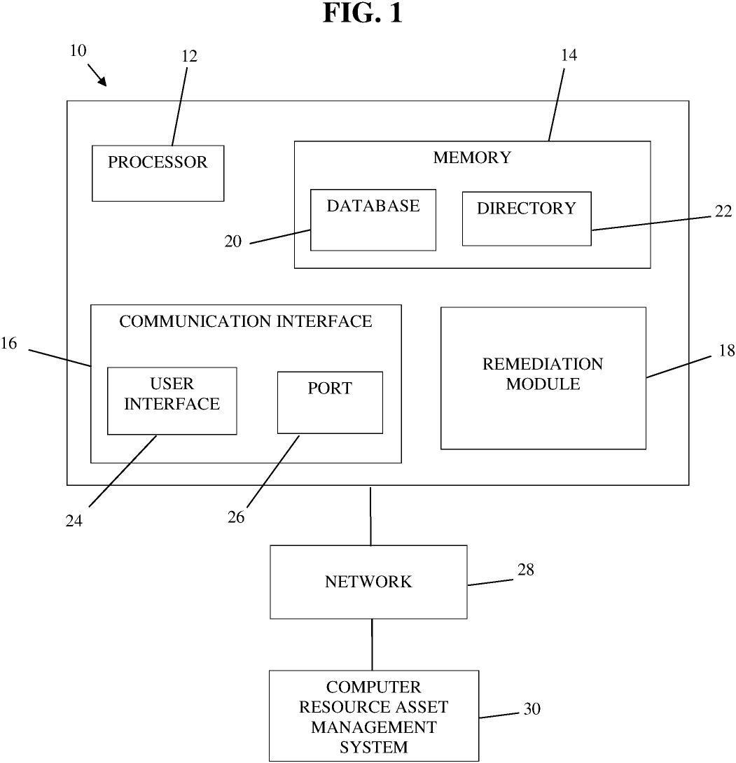

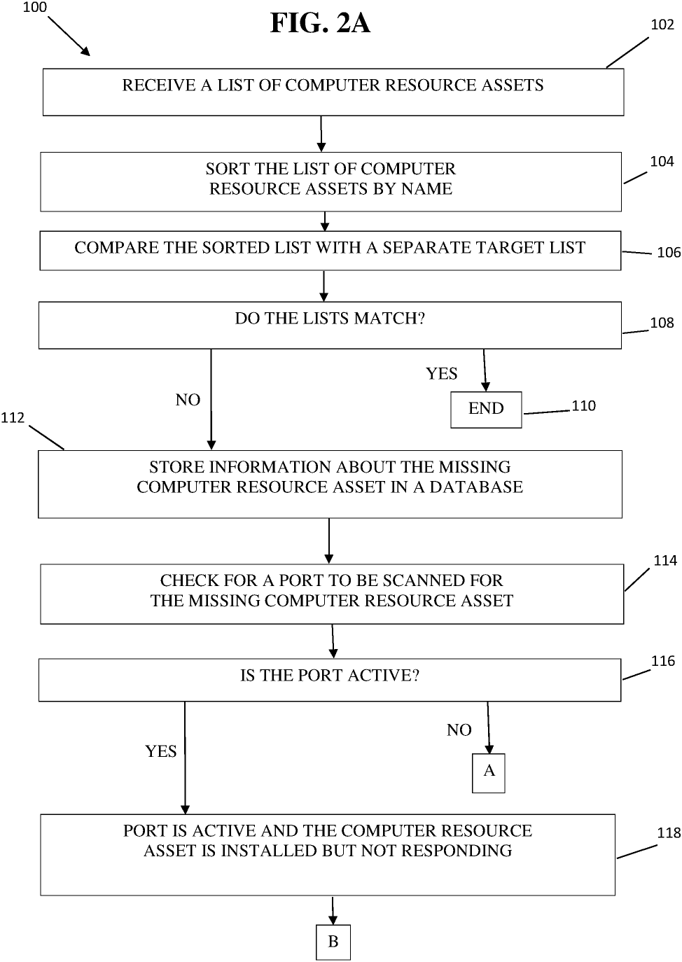

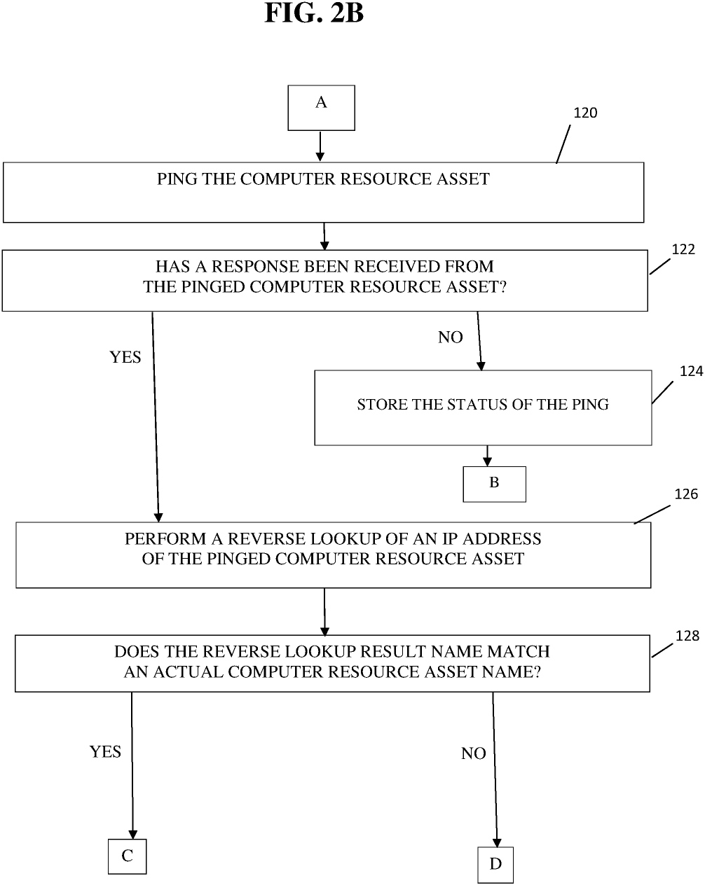

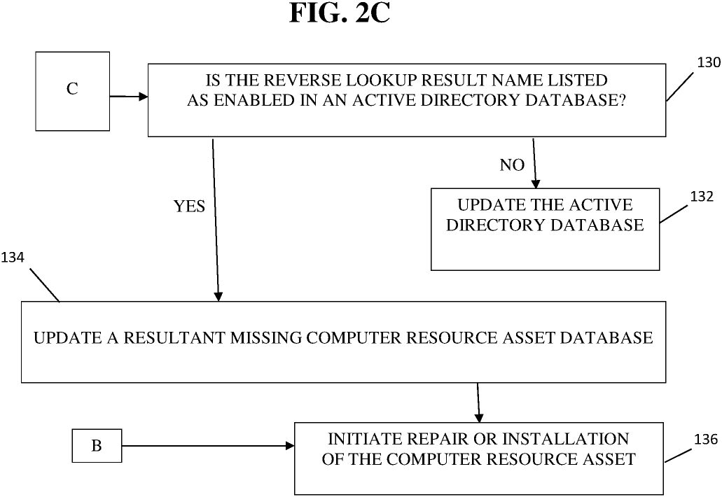

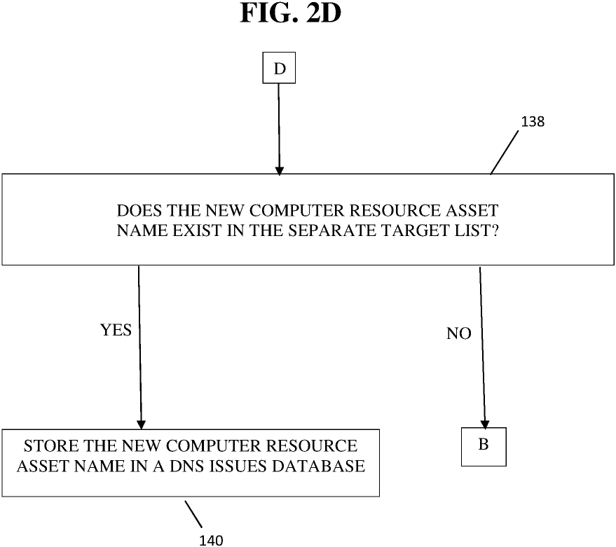

As shown in FIG. 1, a system 10 includes a processor 12, a memory 14, a communication interface 16, and a remediation module 18. The system 10 can be a computer upon which applications are installed. The processor 12 can be a microprocessor. Alternatively, the processor 12 can be a printed circuit board (PCB). The processor 12 can be hardware-based. In addition, the processor 12 can include code therein configured to perform a process, such as the method described below in conjunction with FIGS. 2A-2D. For example, the process can be implemented by hardware. Alternatively, the process can be implemented by a predetermined software application. The predetermined software application can be stored in the memory 14. In addition, the processor 12 can execute the predetermined software application.

The memory 14 includes a database 20 and a directory 22. The database 20 can include a hardware asset management system database. The hardware asset management system database can be a main repository for all hardware assets available or deployed in an organization. Also, the database 20 can include a targeted application database. The targeted application database can include a list of computers running a given targeted application. The targeted application database can also include a last time that each targeted application reported activity. The targeted application database can further include details related to each targeted application and the last time that such a targeted application reported activity.

In addition, the database 20 can include a resultant database for applications. The resultant database can include information about all computers. The resultant database can also include a list of missing applications about a given computer. The resultant database can further include a list of offline computers. The resultant database can also include a list of corrupted applications. In addition, the resultant database can include information about issues. In addition, the issues can include details regarding domain name system (DNS) resolution. Also, the issues can include information about computer duplication.

Furthermore, the database 20 can include an application ports database. The application ports database can be a main repository for information regarding all applications and their corresponding ports. The information can list a port which is supposed to be active on a given client computer when a client application is installed on the client computer.

The directory 22 can include an active directory. In addition, the directory 22 can include Lightweight Directory Access Protocol (LDAP) directory. The LDAP directory can be a main repository for a list of all computer objects. The LDAP directory can also include information about a given computer object. The information can include a last connecting time of a given computer object. The information can also include a current active status of a given computer object. The information can further include other related details about a given computer object.

Referring again to FIG. 1, the communication interface 16 can be any known type of interface. For example, the communication interface 16 can include a user interface 24. The user interface 24 can operate to allow a user to design a reporting schedule for details regarding a computer resource asset. A computer resource asset can include a workstation. Alternatively, a computer resource asset can include a desktop computer. In addition, a computer resource asset can include a laptop computer. Also, a computer resource asset can include a server. Furthermore, a computer resource asset can include a cellphone. In addition, a computer resource asset can include a smartphone. Also, a computer resource asset can include a tablet. A computer resource asset can further include a software application. Still further, a computer resource asset can include an app. Also, a computer resource asset can include an applet. Moreover, a computer resource asset can include a computer object.

In addition, the user interface 24 can be operated by a user to integrate any new application. The integration of a new application can include information regarding installation the new application. The user interface 24 can also be operated by a user to add information about a new application. The user interface 24 can further be operated by a user to add information about a port related to a new application.

The communication interface 16 can also include a port 26. The port 26 can be configured to operate in conjunction with a computer resource asset. For example, the port 26 can be configured to interact with a software application. The communication interface 16 can also include a system integration interface. The system integration interface can allow a user or a computer resource asset to configure access of specific computer resource asset to a database 20. The system integration interface can configure such access using a database connection. Alternatively, the system integration interface can configure such access using an application programming interface (API). An API can pull required information regarding a specific computer resource asset from a source of information. In addition, an API can initiate a process configured to install an application on a specific computer resource asset.

Furthermore, the communication interface 16 can be any known type of interface using a communication protocol to interact with other devices. For example, the communication interface 16 can include a network interface configured to connect with and communicate with a network 28. The communication interface 16 can also be configured to interact with a computer resource asset management system 30. The communication interface 16 can interact with the computer resource asset management system 30 through the network 28.

Referring again to FIG. 1, the remediation module 18 can be a computer resource asset which can have code therein configured to remediate another computer resource asset. The remediation module 18 can be hardware-based. For example, the remediation module 18 can include a processor, a memory, and a communication interface configured to interact with the processor 12, the memory 14, and the communication interface 16. As described in greater detail below, when the processor determines whether a specific computer resource asset is missing from the memory 14 using the process described herein, the remediation module 18 remediates the system 10 to include the specific computer resource asset. The remediation module 18 remediates by repairing an installed computer resource asset to be the missing computer resource asset. Alternatively, the remediation module 18 remediates by installing the missing computer resource asset in the memory 14. For example, when the processor 12 determines that a specific computer application is missing from the system 10, the remediation module 18 installs the missing computer application.

Referring to FIGS. 2A-2D, a method 100 includes receiving a list of computer resource assets in step 102. The list can be imported from the computer resource asset management system 30. The imported list can include a list of workstations, desktops, laptops, servers, and other hardware-based computer resource assets. In addition, the imported list can include all computer objects in an active directory or any LDAP system, with the computer objects reported to the system 10 in a previous predetermined number of days. The predetermined number of days can be configured by an administrator using the user interface 24. For example, the predetermined number of days can be fourteen days. The imported list can also include any computers connected to any defined or targeted software application in a centralized database in a previous predetermined number of hours. The predetermined number of hours can be configured by an administrator using the user interface 24. For example, the predetermined number of hours can be twenty-four hours.

The method 100 then sorts the list of computer resource assets by name in step 104. The method 100 compares the sorted list with a separate target list from a targeted application database in step 106. The method 100 checks whether the lists match in step 108. If the lists match in step 108, there are no missing computer resource assets on the system 10, and the method 100 ends in step 110. Since there are no missing computer resource assets, the system 10 is deemed healthy at the time of performing the method 100. The method 100 can be re-initiated in step 102 after a predetermined number of hours. The predetermined number of hours can be configured by an administrator using the user interface 24. For example, the predetermined number of hours can be twenty-four hours. Accordingly, the system 10 can be automatically checked on a routine basis such as daily or at any selected time interval.

Referring again to step 108, if the lists do not match in step 108, the method 100 proceeds to step 112 to store information about the missing computer resource asset in a database. The method 100 then checks for a port to be scanned for the missing computer resource asset in step 114. The method 100 can determine the port to be scanned from information in a port database for any port associated with a targeted computer resource asset. The scanning of the port can be performed using a known port query tool. Alternatively, the scanning can be performed using a command available in a programming language. Still further, the scanning can be performed using a command available in a scripting language, such as PowerShell, VB Script, or C#. If a port is not active for the computer resource asset as determined in step 116, the method 100 proceeds to step 120 in FIG. 2B. However, if the port is active as determined in step 116, the computer resource asset is installed but is not responding in step 118, and so the computer resource asset has a corrupt installation. The method 100 can optionally store information about the corrupted computer resource asset in a database. The method 100 then proceeds to step 136 in FIG. 2C to be remediated by repairing the installed computer resource asset.

Referring to FIG. 2B, when the computer resource asset is not responding on an associated port, the method 100 pings the computer resource asset in step 120. The method 100 then checks if a response has been received from the pinged computer resource asset in step 122. If no response is received in step 122, the method 100 stores the status of the ping in step 124, and the method 100 proceeds to step 136 in FIG. 2C. However, if a response is received in step 122, the method 100 collects information about the ping including an Internet protocol (IP) address. The method 100 then performs a reverse lookup of the IP address of the pinged computer resource asset in step 126. The reverse lookup can involve a reverse DNS lookup of the IP address. The reverse lookup can also include performing a fully qualified domain name (FQDN) search. The method 100 then checks if the reverse lookup result name matches an actual computer resource asset name in step 128. If there is a match in step 128, the method 100 proceeds to step 130 in FIG. 2C. Otherwise, if there is no match in step 128, the computer resource asset is deemed to be new, and the method 100 proceeds to step 138 in FIG. 2D.

Referring to FIG. 2C, in step 130, the method 100 checks if the reverse lookup result name is listed as enabled in an active directory database. If the reverse lookup result name is not listed as enabled in step 130, the method 100 updates the active directory database in step 132 and the method 100 ends. However, if the reverse lookup result name is listed as enabled in step 130, the computer resource asset is deemed to be missing, and so the method 100 updates a resultant missing computer resource asset database in step 134. The method 100 then initiates repair or installation of the missing computer resource asset in step 136, and the method 100 ends.

Referring to FIG. 2D, in step 138, the method 100 checks if the new computer resource asset name exists in the separate target list. If the new computer resource asset name does not exist in the separate target list in step 138, the method 100 proceeds to step 136 in FIG. 2C. Otherwise, if the new computer resource asset name does exist in the separate target list in step 138, the method 100 stores the new computer resource asset name in a DNS issues database in step 140, and the method 100 ends.

Portions of the methods described herein can be performed by software or firmware in machine readable form on a tangible (e.g., non-transitory) storage medium. For example, the software or firmware can be in the form of a computer program including computer program code adapted to cause the system to perform various actions described herein when the program is run on a computer or suitable hardware device, and where the computer program can be embodied on a computer readable medium. Examples of tangible storage media include computer storage devices having computer-readable media such as disks, thumb drives, flash memory, and the like, and do not include propagated signals. Propagated signals can be present in a tangible storage media. The software can be suitable for execution on a parallel processor or a serial processor such that various actions described herein can be carried out in any suitable order, or simultaneously.

It is to be further understood that like or similar numerals in the drawings represent like or similar elements through the several figures, and that not all components or steps described and illustrated with reference to the figures are required for all embodiments or arrangements.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third) is for distinction and not counting. For example, the use of “third” does not imply there is a corresponding “first” or “second.” Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims.

The subject matter described above is provided by way of illustration only and should not be construed as limiting. Various modifications and changes can be made to the subject matter described herein without following the example embodiments and applications illustrated and described, and without departing from the true spirit and scope of the invention encompassed by the present disclosure, which is defined by the set of recitations in the following claims and by structures and functions or steps which are equivalent to these recitations.

What is claimed is:

1. A method configured to install a missing computer resource asset, comprising:
receiving a management list of computer resource assets from a computer resource asset management system;
sorting the management list according to the names of the listed computer resource assets in the management list;
receiving a target list of computer resource assets;
comparing the sorted management list with the target list;
if the sorted management list does not match the target list, scanning a port for the missing computer resource asset;
if the port is not active, pinging the missing computer resource asset;
if no response to the ping is received, remediating the missing computer resource asset;
if a response to the ping is received, performing a reverse lookup of an IP address of the pinged computer resource asset to obtain a reverse lookup name;
if the reverse lookup name matches an actual computer resource asset name, checking whether the reverse lookup name is listed as enabled in an active directory database;
if the reverse lookup name is listed as enabled in an active directory database, remediating the pinged computer resource asset;
if the reverse lookup name does not match an actual computer resource asset name, checking whether the reverse lookup name is listed in the separate target list; and
if the reverse lookup name is not listed in the separate target list, remediating the pinged computer resource asset.

2. The method of claim 1, wherein the computer resource assets are selected from the group consisting of: a workstation, a desktop computer, a laptop computer, a server, a cellphone, a smartphone, a tablet, a software application, an app, an applet, and a computer object.

3. The method of claim 1, wherein the remediating includes repairing the computer resource asset or installing the computer resource asset.

4. The method of claim 1, further comprising:
if the port is active, remediating the missing computer resource asset.

5. The method of claim 1, wherein performing the reverse lookup includes performing a fully qualified domain name (FQDN) search.

6. The method of claim 1, wherein the management list includes a current deployment status of each computer resource asset in the management list.

7. The method of claim 1, wherein the management list includes all computer objects in a directory reported in a previous predetermined number of days.

8. The method of claim 1, wherein the management list includes all computer resource assets connected to a centralized database in a previous number of hours.

9. A method configured to install a computer application missing from a computer system, comprising:
receiving, at the computer system, a management list of computer applications from a computer resource asset management system;
sorting the management list according to the names of the listed computer applications in the management list;
receiving a target list of computer applications;
comparing the sorted management list with the target list;
if the sorted management list does not match the target list, scanning a port for the missing computer application;
if the port is not active, pinging the missing computer application;
if no response to the ping is received, remediating the missing computer application;
if a response to the ping is received, performing a reverse lookup of an IP address of the pinged computer application to obtain a reverse lookup name;
if the reverse lookup name matches an actual computer application name, checking whether the reverse lookup name is listed as enabled in an active directory database;
if the reverse lookup name is listed as enabled in an active directory database, remediating the pinged computer application;
if the reverse lookup name does not match an actual computer application name, checking whether the reverse lookup name is listed in the separate target list; and
if the reverse lookup name is not listed in the separate target list, remediating the pinged computer application.

10. The method of claim 9, wherein the computer applications are selected from the group consisting of: a software application, an app, an applet, and a computer object.

11. The method of claim 9, wherein the remediating includes repairing the computer application or installing the computer application.

12. The method of claim 9, further comprising:
if the port is active, remediating the missing computer application.

13. The method of claim 9, wherein performing the reverse lookup includes performing a fully qualified domain name (FQDN) search.

14. The method of claim 9, wherein the management list includes a current deployment status of each computer application in the management list.

15. The method of claim 9, wherein the management list includes all computer objects in a directory reported in a previous predetermined number of days.

16. The method of claim 9, wherein the management list includes all computer applications connected to a centralized database in a previous number of hours.

17. A computer system, comprising:
a processor having code therein configured to operate a plurality of computer applications, including a predetermined computer application;
a memory configured to store a database of information regarding each computer application;
a communication interface operatively connected to a computer application management system; and
a remediation module having code therein configured to remediate the plurality of computer applications,
wherein the processor determines whether a specific computer application is missing from the memory using the predetermined computer application, and
wherein the remediation module, responsive to the predetermined computer application, remediates the plurality of computer applications to include the specific computer application.

18. The computer system of claim 17, wherein the remediation module remediates by repairing an installed computer application to be the missing computer application or by installing the missing computer application in the memory.

19. The computer system of claim 17, wherein the communication interface includes a port, and
wherein the processor determines whether the missing computer application is active on the port.

20. The computer system of claim 17, wherein the processor receives a management list of computer applications from the computer application management system, and determines whether there is a match of the management list with a target application list stored in the memory; and
wherein, if there is no match, the remediation module remediates the plurality of computer applications to include the specific computer application.
